(19) United States
(12) Patent Application Publication
(10) Pub. No.: US 2008/0026291 A1
(43) Pub. Date: Jan. 31, 2008

(54) RECHARGEABLE BATTERY

(75) Inventor: Yong-Sam Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/748,742

(22) Filed: May 15, 2007

(30) Foreign Application Priority Data
Jul. 27, 2006 (KR) 2006-70760

(51) Int. Cl. H01M 4/02

(52) U.S. Cl. 429/211

(57) ABSTRACT

A rechargeable battery capable having increased current collection efficiency and an improved current collecting plate. The rechargeable battery includes: an electrode group which includes positive and negative electrode, and a separator interposed between the positive and negative electrode; a casing in which the electrode group is inserted; a cap assembly to seal the casing, and including an external terminal that is electrically connected to the electrode group; and a current collecting plate which is electrically connected to at least one electrode among the positive and negative electrode, and including a body with a first thickness and welding portions with a second thickness that is less than the first thickness.

### CROSS-REFERENCE TO RELATED APPLICATIONS

This application claims the benefit of Korean Application No. 2006-70760, filed Jul. 27, 2006, in the Korean Intellectual Property Office, the disclosure of which is incorporated herein by reference.

### BACKGROUND OF THE INVENTION

1. Field of the Invention

Aspects of the present invention relate to a rechargeable battery, and more particularly, to a rechargeable battery having an improved current collecting plate.

2. Description of the Related Art

In general, rechargeable batteries can be repeatedly charged and discharged, unlike primary batteries.

Low capacity rechargeable batteries have been used in portable compact electronic devices such as mobile phones, laptop computers, and camcorders. High capacity rechargeable batteries, in which a plurality of cells are connected in a package form, have been widely used as a power supply for driving motors of movable electric apparatuses, such as hybrid electric vehicles (HEV).

A rechargeable battery (unit battery) includes: an electrode group having positive and negative electrode, and a separator interposed between the positive and negative electrode; a casing having a space to store the electrode group; and a cap assembly to seal the casing.

In unit batteries, the casings have been manufactured in various shapes, such as cylindrical and rectangular shapes.

Conductive taps to collect the current generated during charging and discharging, are fixed to the positive and negative electrode. The conductive taps are fixed to the electrode group by welding, to provide a pathway for the current generated in the positive and negative electrode to move to the positive and negative terminals.

In high capacity rechargeable batteries, current collecting plates are employed instead of the taps to reduce the resistance of the batteries.

The current collecting plates are fixed to plain parts of the electrode group by laser welding. The current collecting plates need to have a large thickness so as to have a low specific resistance. However, as the thickness of the current collecting plates increases, the heat transferred to the current collecting plates during welding, becomes more dispersed, and the weld between the current collecting plates and the plain parts weakens. Accordingly, the current collecting plates need to have a thickness of 0.3 mm, or less, so as to produce a stable weld.

However, leads for connecting the current collecting plates and the terminals need to have a thickness of 0.4 mm, or more, so as to reduce the resistance of the leads. As described above, since the allowable thickness of the current collecting plates is different from that of the leads, it is impossible to form the current collecting plates and the leads as one body. Accordingly, separate leads have to be connected to the current collecting plates.

Accordingly, since the current collecting plates have to be connected to the leads by welding, the manufacturing processes are complicated, reducing productivity. In addition, the efficiency of the current collection deteriorates, due to contact resistance between the current collecting plates and the leads.

### SUMMARY OF THE INVENTION

Aspects of the present invention provide a rechargeable battery having an increased current collection efficiency, due to an improved current collecting plate.

Aspects of the present invention also provide a rechargeable battery having properties that improve the welding of a current collecting plate to an electrode group, by improving the structure of the current collecting plate.

According to an aspect of the present invention, there is provided a rechargeable battery comprising: an electrode group that includes positive and negative electrode and a separator interposed between the positive and negative electrode; a casing in which the electrode group is inserted; a cap assembly to seal the casing, the cap assembly including an external terminal that is electrically connected to the electrode group; and a current collecting plate that is electrically connected to at least one of the positive and negative electrode.

The current collecting plate includes a body with a first thickness and, grooves having welding portions. The welding portions have a second thickness that is less than the first thickness. The current collecting plate may be disposed in contact with positive plain parts of the positive electrode. In addition, the current collecting plate may be disposed in contact with negative plain parts of the negative electrode. A lead may be integrated into one edge of the body. The thickness of the body may be substantially the same as that of the lead. The second thickness may range from 0.15 times to 0.75 times that of the first thickness. The first thickness may range from 0.4 mm to 0.8 mm. The second thickness may range from 0.1 mm to 0.3 mm. The current collecting plate may be connected to the electrodes by laser welding.

The grooves can extend radially from the center of the body. The grooves may extend from the center of the body as helices or arcs. The grooves may have a semi-polygonal longitudinal cross section. The grooves may have a V-shaped, U-shaped, or semi-circular longitudinal cross sections.

Plain part contact portions, which are protrusions below the grooves can contact the plain parts of the electrodes, may be formed in the body. The height of the plain part contact portions may range from 0.125 times to 1 times that of the first thickness, as measured from a surface of the current collecting plate.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross sectional view illustrating a rechargeable battery, according to a first embodiment of the present invention;

FIG. 2 is a perspective view illustrating a positive current collecting plate of the rechargeable battery, according to the first embodiment of the present invention;

FIG. 3 is a cross sectional view taken along line III-III of FIG. 2;

FIG. 4 is a perspective view illustrating a negative current collecting plate of the rechargeable battery, according to the first embodiment of the present invention;

FIG. 5 is a cross sectional view illustrating a current collecting plate of a rechargeable battery, according to a second embodiment of the present invention;

FIG. 6 is a cross sectional view illustrating a current collecting plate of a rechargeable battery, according to a third embodiment of the present invention;

FIG. 7 is a perspective view illustrating a current collecting plate of a rechargeable battery, according to a fourth embodiment of the present invention;

FIG. 8 is a cross sectional view taken along line VIII-VIII of FIG. 7; and

FIG. 9 is a perspective view illustrating a current collecting plate of a rechargeable battery, according to a fifth embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. As those skilled in the art would realize, the described embodiments may be modified in various different ways, all without departing from the spirit or scope of the present invention.

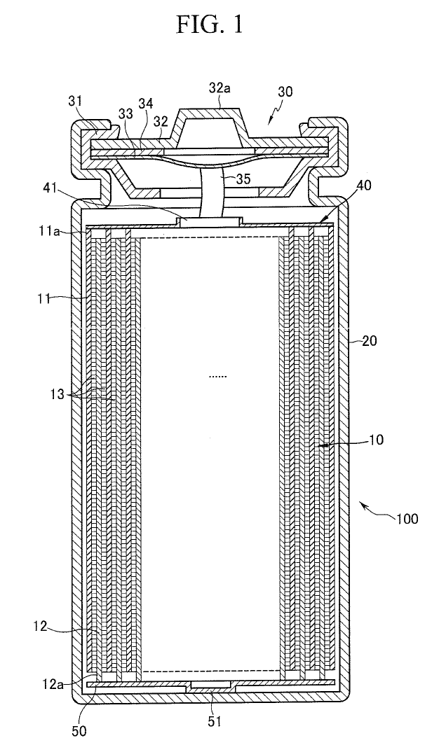

FIG. 1 is a cross sectional view illustrating a rechargeable battery 100, according to a first embodiment of the present invention.

In FIG. 1, the rechargeable battery 100 includes: an electrode group 10 having positive and negative electrode 11 and 12, and a separator 13 interposed between the positive and negative electrode 11 and 12; a casing 20 defining a space to store the electrode group 10, and having an opening on one side; and a cap assembly 30 attached to the opening of the casing 20, to seal the casing 20.

Positive and negative current collecting plates 40 and 50 are fixed to positive and negative plain parts 11a and 12a, respectively. The positive current collecting plate 40 includes a lead that is integrated into the positive current collecting plate 40, to electrically connect the electrode group 10 to the cap assembly 30.

The casing 20 is made of a conductive metal, such as aluminum, an aluminum alloy, or nickel-plated steel. The casing 20 has a cylindrical shape and defines an inner space to store the electrode group 10. Although the casing 20 is shown having a cylindrical shape, the invention is not limited thereto, in that the casing 20 may have a variety of shapes, such as, a rectangular shape.

The cap assembly 30 is electrically connected to the positive current collecting plate 40, via the lead 35. The cap assembly 30 includes a cap plate 32 from which an external terminal 32a protrudes, and gaskets 31 to insulate the cap plate 32 from the casing 20. In addition, the cap assembly 30 further includes a vent plate 33, which can be opened by pressure to discharge gas, and a collar plate 34 that is interposed between the cap plate 32 and the vent plate 33, so as to improve welding efficiency.

The positive electrode 11, the separator 13, and the negative electrode 12, are stacked and wound in a jelly-roll shape, to form the electrode group 10. However, the invention is not limited thereto, in that the electrode group may have a structure in which the positive electrode 11 and the negative electrode 12 are alternately stacked, by interposing a separator between the positive electrode 11 and the negative electrode 12.

A structure constructed by electrically connecting the positive and negative plain parts 11a and 12a, to the positive and negative current collecting plates 40 and 50, respectively, is exemplified. Aspects of the present invention are not limited to the aforementioned structure, and the present teachings can be applicable regardless of the shape of a battery, or the structure of plain parts.

An electrode assembly includes the electrode group 10, the positive current collecting plate 40 that is electrically connected to the positive electrode 11, and the negative current collecting plate 50 that is electrically connected to the negative electrode 12.

The positive current collecting plate 40 is welded to the positive plain parts 11a, which are not coated with a positive activation material. Similarly, the negative current collecting plate 50 is welded to the negative plain parts 12a, which are not coated with a negative activation material.

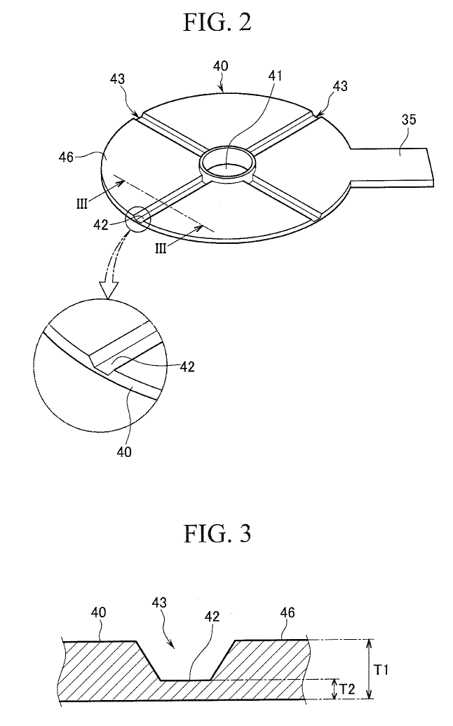

Referring to FIGS. 2 and 3, the positive current collecting plate 40 will be described in the following.

According to aspects of the first embodiment of the present invention, the positive current collecting plate 40 is disk shaped, and is sized to substantially correspond to the cross section of the electrode group 10. The positive current collecting plate 40 includes: a body 46 having a first thickness T1; a lead 35 that is integrated into one edge of the body 46; and grooves 43 each having a welding portion 42. The welding portions 42 having a second thickness T2 that is less than the first thickness. A hole 41 to inject electrolyte is formed in the center of the positive current collecting plate 40.

The first thickness T1 is substantially the same as the thickness of the lead 35. The lead 35 should be thick enough for the lead 35 to have a low specific resistance. Accordingly, the first thickness T1 and/or the thickness of the lead 35 may range from 0.4 mm to 0.8 mm.

When the first thickness T1 is 0.4 mm or less, the resistance of the lead 35 is increased, thereby reducing the current collection efficiency. When the first thickness T1 is 0.8 mm or more, the weight of the lead 35 is increased, thereby increasing the weight of the rechargeable battery 100, and the manufacturing costs of the current collecting plate 40 and the lead 35.

When the first thickness T1 is substantially the same as the thickness of the lead 35, the body 46 and the lead 35 can be formed as one unit. Accordingly, a decrease in the current collection efficiency, due to the contact resistance between the positive current collecting plate 40 and the lead 35, can be prevented.

In addition, the charging and discharging efficiency can be improved, by reducing the specific resistance of the positive current collecting plate 40, by increasing the thickness of the positive current collecting plate 40.

When the first thickness T1 is increased, a weld between the current collecting plate 40 and the positive plain parts 11a may have defects. However, the current collecting plate 40, has a structure suitable for laser welding. This suitability can result from the reduced thickness of the welding portions 42.

The grooves 43 have a semi-trapezoidal longitudinal cross section. The grooves 43 extend radially from the hole 41. The grooves 43 are formed on a first side of the body that does not contact the electrodes.

Since the welding portions 42 have the second thickness T2 that is less than the first thickness T1, laser welding can be suitably performed. In the embodiment, the second thickness T2 ranges from 0.1 mm to 0.2 mm. Accordingly, the second thickness T2 is less than the first thickness T1 by at least 1 mm. The second thickness T2 ranges from 0.15 times to 0.75 times that of the first thickness T1.

When the second thickness T2 is 0.1 mm or less, a laser can heat the welding portions 42, and melt the positive plain parts 11a. When the second thickness T2 is 0.3 mm or more, problems can occur when welding the welding portions 42 to the positive plain parts 11a.

In the positive current collecting plate 40, according to the embodiment of the present invention, the body 46 and the lead 35 are formed as one unit. Because the first thickness T1 is large, and the body 46 and the plain parts 11a can be more suitably welded at the welding portions 42.

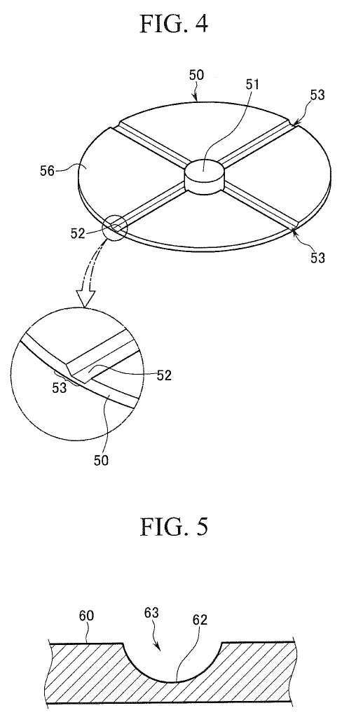

The aforementioned structure may also be generally applied to the negative current collecting plate 50. The negative current collecting plate 50 will now be described, with reference to FIG. 4.

The negative current collecting plate 50 includes a disk-shaped body 56, a circular protrusion 51, and grooves 53 having welding portions 52. The disk-shaped body 56 is sized to substantially correspond to the cross-section of the electrode group 10. The circular protrusion 51, is used to weld the collecting plate to the casing 20, and is formed at the center of the body 56.

The grooves 53 extend from the central protrusion 51, and are formed on a first side of the body 56 that does not contact the negative plain parts 12a. The welding portions 52 are welding lines where laser welding, between the welding portions 52 and the negative plain parts, is performed. The grooves 53 have a semi-trapezoidal longitudinal cross section.

In the embodiment, the negative current collecting plate 50 has a thickness corresponding to that of the positive current collecting plate 40. A first thickness of the body 56, ranges from 0.4 mm to 0.8 mm, and is similar to that of the positive current collecting plate 40.

A second thickness relating to the thickness of the welding portions 52, is a thickness in which laser welding can be performed. In the embodiment, the second thickness ranges from 0.1 mm to 0.3 mm. Accordingly, the second thickness ranges from 0.15 times to 0.75 times that of the first thickness.

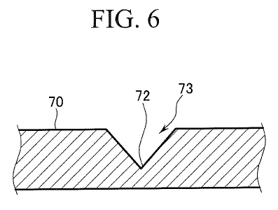

Although the grooves 53 are shown as having a semi-trapezoidal longitudinal cross section, the invention is not limited thereto. The grooves may have various shapes or combinations of different shapes. For example, as shown in FIG. 5, a groove 63, having a semi-circular cross section, may be formed on a current collecting plate 60. A welding portion 62 is disposed at the bottom of the groove 63. As shown in FIG. 6, a groove 73 can have a V-shaped cross section, and can be formed on a current collecting plate 70. A welding portion 73 is disposed at the bottom of the groove 73.

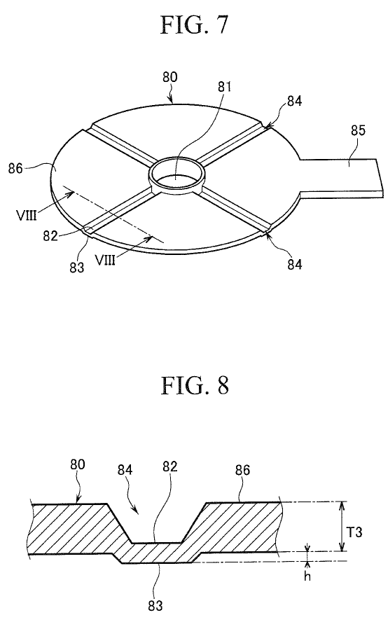

FIG. 7 is a perspective view illustrating a current collecting plate 80 of a rechargeable battery, according to a fourth embodiment of the present invention. FIG. 8 is a cross sectional view taken along line VIII-VIII, of FIG. 7.

Referring to FIGS. 7 and 8, the current collecting plate 80 includes a body 86 and a lead 85. The body is disk-shaped and can be used as a positive current collecting plate. The lead 85 is integrated into one edge of the body 86. The current collecting plate 80 includes grooves 84 having welding portions 82. The welding portions 82 have a thickness of less than that of the body 86. A hole 81, to inject electrolyte, is formed at the center of the body 86.

The grooves 84 have a semi-trapezoidal longitudinal cross section. When laser welding is performed, the thickness of the welding portions 82 is less than the thickness of the body 86, so that the heat from the welding cannot dissipate before welding is completed.

Plain part contact portions 83 are protrusions formed below the grooves 84. The plain part contact portions 83 protrude from a second side of the current collecting plate 80. When the current collecting plate 80 is welded to electrodes, the plain part contact portions 83 contact plain parts of the electrodes. When the current collecting plate 80 contacts the plain parts, the plain part contact portions 83 are pressed against the plain parts, and bend the plain parts, thereby increasing the contact areas between the welding portions 82 and the plain parts. When the contact areas between the welding portions 82 and the plain parts are increased, a weld formed therebetween can be improved.

A protrusion height H, of the plain part contact portions 83, ranges from 0.125 times to 1 times a thickness T3 of the body 86. When the protrusion height H is less than 0.125 times the thickness T3, the plain parts may not be suitably bent during the pressing of the plain parts.

When the protrusion height H is greater than the thickness T3, the plain parts can be excessively bent, and irregularly folded. In a winding-type electrode group, when the plain parts are excessively bent, other parts connected thereto (the current collector of the electrodes, which is coated with an activation material) are also bent. In this case, the irregularly curved and folded plain parts protrude, the plain parts irregularly contact the current collecting plate, and the contact between the plain parts and the current collecting plate deteriorates. This results in problems in the collection of current, due to a reduction in size of the contact areas.

Although the current collecting plate 80 is exemplified in the fourth embodiment as a positive current collecting plate, the taught structure can be applied to a negative current collecting plate.

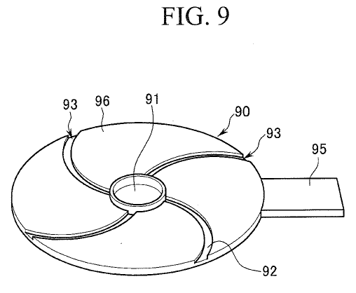

FIG. 9 is a perspective view illustrating a current collecting plate 90, of a rechargeable battery, according to a fifth embodiment of the present invention. Referring to FIG. 9, the current collecting plate 90 includes a body 96 having a disk-shape. A lead 95 is integrated into one side of the body 96.

A hole 91 to inject electrolyte is formed at the center of the body 96. Grooves 93, extend from the hole 91 to the outer edge of the current collecting plate 90, in a helical shape. Like the aforementioned embodiments, welding portions 92 have a thickness that is less than that of the body 96.

The helical shape of the grooves 93 gives the welding portions 92 a greater length as compared to welding portions that extend radially in straight lines from the center of a collecting plate. The welding portions 92 are can be disposed adjacent to the plain parts, and the amount of current collected through the welding portions 92 can be uniform.

The charging and discharging efficiencies may be different for each part of an electrode group, depending on the amount of the activation material, and the electrolyte concentration. Accordingly, since the amount of the current collected in the plain parts differs for each part, excessive current can flow through a specific welding portion. When an excessive current flows through a specific welding portion, resistance heat is generated therein, thereby decreasing the current collection efficiency. However, according to the fifth embodiment of the present invention, since the grooves 93, and the associated welding portions 92, extend in a helical shape, the welding portions 92 more uniformly contact the plain parts, thereby alleviating the aforementioned problem.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A rechargeable battery comprising:
an electrode group comprising positive electrode, negative electrode, and a separator disposed between the positive electrode and the negative electrode;
a casing disposed around the electrode group;
a cap assembly disposed on one end of the casing, and comprising an external terminal electrically connected to the electrode group; and
a current collecting plate electrically connected to at least one electrode selected from the positive electrode and the negative electrode, and comprising a body having a first thickness and comprising grooves,
wherein the grooves each have a welding portion having a second thickness that is less than the first thickness.

2. The rechargeable battery of claim 1, wherein:
the positive electrode further comprise positive plain parts; and
the current collecting plate contacts the positive plain parts.

3. The rechargeable battery of claim 1, wherein:
the negative electrode further comprise negative plain parts; and
the current collecting plate contacts the negative plain parts.

4. The rechargeable battery of claim 1, wherein the body further comprises a lead disposed on an edge thereof.

5. The rechargeable battery of claim 4, wherein the lead has a thickness, and the first thickness of the body is substantially the same as the thickness of the lead.

6. The rechargeable battery of claim 1, wherein the second thickness ranges from 0.15 times to 0.75 times the first thickness.

7. The rechargeable battery of claim 6, wherein the first thickness ranges from 0.4 mm to 0.8 mm.

8. The rechargeable battery of claim 1, wherein the second thickness ranges from 0.1 mm to 0.3 mm.

9. The rechargeable battery of claim 1, wherein the current collecting plate is electrically connected to the least one the positive electrode and the negative electrode, by laser welding.

10. The rechargeable battery of claim 1, wherein the body has a hole disposed in the center thereof.

11. The rechargeable battery of claim 1, wherein the grooves extend in a radial pattern from the center of the body.

12. The rechargeable battery of claim 1, wherein the grooves extend in a helical pattern from the center of the body.

13. The rechargeable battery of claim 1, wherein the grooves have a semi-polygonal longitudinal cross section.

14. The rechargeable battery of claim 1, wherein the grooves have a semi-circular longitudinal cross section.

15. The rechargeable battery of claim 1, wherein:
the grooves are disposed on a first surface of the body;
the body further comprises plain part contact portions that protrude from a second surface of the body; and
the plain part contact portions are disposed in opposition to the grooves.

16. The rechargeable battery of claim 15, wherein the plain part contact portions protrude from the second surface to a height that ranges from 0.125 times to 1 times the first thickness.

17. The rechargeable battery of claim 1, wherein the current collecting plate comprises a protrusion disposed in the center of the body.

18. A rechargeable battery comprising:
an electrode group comprising a plurality of positive electrode, a plurality of negative electrode, and a separator disposed between the positive electrode and the negative electrode;
a casing disposed around the electrode group;
a cap assembly disposed on one end of the casing, and comprising an external terminal electrically connected to the electrode group;
a first current collecting plate electrically connected to the positive electrode, having a first thickness, and comprising a first plurality of grooves; and
a second current collecting plate electrically connected to the negative electrode, having the first thickness, and comprising a second plurality of grooves,
wherein the grooves, of the first plurality of grooves and the second plurality of grooves, each comprise a welding portion having a second thickness that is less than the first thickness.

19. The rechargeable battery of claim 18, wherein the plurality of grooves have a longitudinal cross-sectional shape selected from the group consisting of a semi-trapezoidal shape, a semi-circular shape, a V-shape, and a combination thereof.

20. The rechargeable battery of claim 18, wherein the first and second pluralities of grooves extend from the centers of the current collecting plates in one of a radial pattern, a helical pattern, and a combination thereof.

21. The rechargeable battery of claim 18, wherein:
the first current collecting plate further comprises a lead disposed on an edge thereof; and
the lead has the same thickness as the first thickness.

22. The rechargeable battery of claim 18, wherein:
the welding portions of the first plurality of grooves are welded to the positive electrode; and
the welding portions of the second plurality of grooves are welded to the positive electrode.

23. The rechargeable battery of claim 18, wherein the first thickness ranges from 0.4 mm to 0.8 mm.

24. The rechargeable battery of claim 18, wherein the second thickness ranges from 0.1 mm to 0.3 mm.

25. The rechargeable battery of claim 1, wherein the second thickness ranges from 0.1 mm to 0.3 mm.
